(19) United States
(12) Patent Application Publication
(10) Pub. No.: US 2025/0130310 A1
(43) Pub. Date: Apr. 24, 2025

(54) RADAR SENSOR

(71) Applicant: Robert Bosch GmbH, Stuttgart (DE)

(72) Inventors: Manuel Simon Reiter, Stuttgart (DE); Christian Hollaender, Rheinstetten (DE); Gustav Klett, Moessingen (DE)

(21) Appl. No.: 18/833,695

(22) PCT Filed: Mar. 1, 2023
(86) PCT No.: PCT/EP2023/055128

§ 371 Date: Jul. 26, 2024

(30) Foreign Application Priority Data
Apr. 13, 2022 (DE) 10 2022 203 714.6

(51) Int. Cl. G01S 7/03; G01S 7/02; G01S 13/931

(52) U.S. Cl. CPC G01S 7/03; G01S 7/028; G01S 13/931

(57) ABSTRACT

A radar sensor. The radar sensor has a waveguide antenna, a radome, a housing to which the radome is fastened, and a printed circuit board in which the waveguide antenna is positioned. The waveguide antenna and the radome are connected to each other in a form-fitting manner.

### FIELD

The present invention relates to a radar sensor having a waveguide antenna and a radome. The radar sensor may, for example, be used in the automotive industry.

### BACKGROUND INFORMATION

Of late, waveguide antennas having a waveguide structure for transmitting and receiving radar waves are often used in radar sensors. The waveguide antennas are connected to printed circuit boards and are supplied with radar waves via electrical components located on the printed circuit board. The waveguide antennas are traditionally fastened directly onto the printed circuit board. In order to protect the radar sensor and the waveguide antenna from external influences, the radar sensor has a radome. The radome is arranged in the emission direction, i.e., typically on the side of the antenna opposite the printed circuit board, and is permeable to the radar waves. The radome is usually fastened to a housing of the radar sensor to which the printed circuit board is also fastened.

### SUMMARY

According to the present invention, a radar sensor having a waveguide antenna and a radome is provided, wherein the radome and the waveguide antenna are connected to each other in a form-fitting manner. The waveguide antenna and the radome are thus already rigidly connected to each other before being mounted on the radar sensor. In other words, the waveguide antenna is integrated into the radome. The waveguide antenna and the radome can thus be produced in advance as an assembly and, in doing so, can already be adapted to one another, thereby simplifying production. Since the radome and the waveguide antenna are rigidly connected to each other, the distance between the emitting surface of the waveguide antenna and the radome, this distance being important for the performance of the radar sensor, does not change, even in the event of vibration or deformation.

Finally, the assembly is mounted on a housing of the radar sensor. In this process, the radome is preferably fastened to the housing by means of a laser welding method. Distance dimensions previously ascertained for the manufacture of the radar sensor and the radome-waveguide antenna assembly can be used as input parameters for the laser welding method. It is thus possible to set the distance between the waveguide antenna and the printed circuit board precisely. In the mounting process, the waveguide antenna is positioned by the printed circuit board in that positioning elements of the waveguide antenna engage in corresponding guide elements of the printed circuit board. By way of example, the positioning elements are formed as pins extending from the waveguide antenna, and the guide elements are openings in the printed circuit board. The pins engage in the corresponding openings for guidance.

Since the waveguide antenna is already rigidly fastened to the radome, it is possible to dispense with a further fastening of the waveguide antenna to the printed circuit board. The radome-waveguide antenna assembly is secured only via the fastening of the radome to the housing. It is thus possible to provide fewer fastening elements and/or guide elements on the printed circuit board, which reduces the space required on the printed circuit board. In particular, two guide elements on the printed circuit board are sufficient for fastening the assembly. A lateral offset in position between launchers on the printed circuit board and ports of the waveguide antennas can be compensated by the positioning elements and/or guide elements via a short tolerance chain.

Through the fastening via the housing, the waveguide antenna and the printed circuit board are decoupled from each other. The forces acting on the waveguide antenna are not absorbed by the printed circuit board, resulting in a lower load on the connection between the printed circuit board and the housing, in particular when the radar sensor is exposed to vibration loads.

According to an example embodiment of the present invention, for the form-fitting connection technique, the radome preferably has pins which extend through the waveguide antenna, preferably to the opposite side, and are connected to the waveguide antenna. The pins make a simple form-fitting connection possible.

According to an example embodiment of the present invention, a heat staking process may be used as the preferred form-fitting connection technique. In heat staking, plastics domes are melted by heat and then deformed under pressure. The aforementioned pins of the radome, which act in this case as heat staking pins, are preferably used as plastics domes. The heat staking pins of the radome extend through the waveguide antenna and are then melted and deformed on the opposite side so that they bear against the waveguide antenna. The waveguide antenna preferably has a recess in which the deformed heat staking pin engages.

The waveguide antenna optionally has at least one projection extending from the main body in which the waveguides are formed. The radome is connected in a form-fitting manner to the waveguide antenna on this at least one projection. The pins, in particular the heat staking pins, can preferably extend through this at least one projection and engage therein on the opposite side. Consequently, the form-fitting connection is achieved outside the main body of the waveguide antenna, meaning that no space on the main body is required for the form-fitting connection. As a result, relatively small overall designs can be achieved.

Furthermore, a method for producing a radar sensor is provided according to the present invention. According to an example embodiment of the present invention, initially, a waveguide antenna and a radome are provided. The waveguide antenna and the radome are adapted in shape and size to each other as well as to a housing and a printed circuit board, to which they are subsequently connected. The distances between the waveguide antenna and the printed circuit board are also defined. The waveguides are already formed correspondingly in the waveguide antenna. The radome is then connected in a form-fitting manner to the waveguide antenna to form a radome-waveguide antenna assembly. As described above, a heat staking process is used as the preferred form-fitting connection technique. The aforementioned steps are already carried out before the assembly is mounted on the housing and the printed circuit board. The radome-waveguide antenna assembly can thus be produced and supplied in advance, for example by a supplier. Finally, during assembly, the radome-waveguide antenna assembly is mounted, with the radome, to the housing. The laser welding method described above is preferably used to connect the radome to the housing.

As a whole, the radar sensor can be produced cost-effectively with standardized processes for high-volume series production.

### BRIEF DESCRIPTION OF THE DRAWINGS

Embodiment examples of the present invention are shown in the drawings and explained in more detail in the following description.

FIG. 1 shows a cross section through a radar sensor according to the present invention in accordance with a first example embodiment.

FIG. 2 shows a cross section through a radar sensor according to the present invention in accordance with a second example embodiment.

FIGS. 3A-3D show top views of a waveguide antenna with heat staking pins of a radome in various arrangements, according to example embodiments of the present invention.

### DETAILED DESCRIPTION OF EXAMPLE EMBODIMENTS

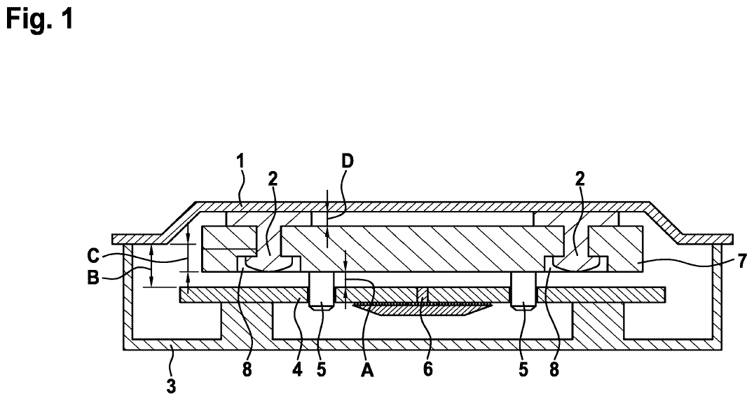

FIG. 1 shows a first embodiment of the radar sensor according to the present invention. The radar sensor has a waveguide antenna 7, a radome 1, a housing 3 and a printed circuit board 4. The printed circuit board 4 has a chip 6 with a launcher, which generates radar waves. The printed circuit board 4 is fastened directly to the housing 3. According to the present invention, the waveguide antenna 7 is connected to the radome 1 in a form-fitting manner. For this purpose, the radome 1 has heat staking pins 2, two of which are shown in FIG. 1. The heat staking pins 2 are inserted into openings in the waveguide antenna 7 during production and extend through the openings to the opposite side, which is opposite the emitting surface and which is referred to here as the rear face. On the rear face, at the location of each heat staking pin 2, the waveguide antenna 7 in this embodiment example has a recess 8, into which a head of the heat staking pin 8 projects. In the heat staking process, the head of the heat staking pin 2 is pressed against the rear face by means of heat and pressure and thus deformed so that the waveguide antenna 7 is “clamped” by the heat staking pins 2, and a form-fitting connection is created. An integral radome-waveguide antenna assembly is thus formed. In the heat staking process, the distance D between the emitting surface of the waveguide antenna 7 and the radome 1 is defined via a tool-specific dimension, this distance being important for the performance of the radar sensor. Due to the form-fitting connection, the distance D remains the same throughout the service life of the radar sensor and is protected from vibrations and other deformations.

The waveguide antenna 7 also has pin-shaped positioning elements 5 on the rear face. When the radome 1 and the waveguide antenna 7 are mounted on the housing 3 and the printed circuit board 4, the positioning elements 5 are pre-centered in a pre-joining step by openings in the printed circuit board 4. The positioning elements 5 ensure the lateral position of the waveguide antenna 7 with respect to the launcher on the chip 6 during the pre-joining, the laser welding and the final installation of the radar sensor. In the mounting process, the radome 1 is connected to the housing 3 by means of a laser welding method. In this process, the distance A between the waveguide antenna 7 and the printed circuit board 4, which is important for correct coupling or decoupling of the radar waves, is set. In order to set the distance A, the distance B between the connection point of the radome 1 and the printed circuit board 4 as well as the distance C between the connection point of the radome 1 and the rear face of the waveguide antenna 7 are ascertained. The distance C is ascertained when connecting the radome 1 and the waveguide antenna 7 and is then transmitted to a manufacturing station of the laser welding method by means of a data matrix code or another type of data transmission. Prior to laser welding, the distance B is then calculated from the sum of the distance C and the previously defined distance A, and the laser welding method is carried out using the calculated distance B.

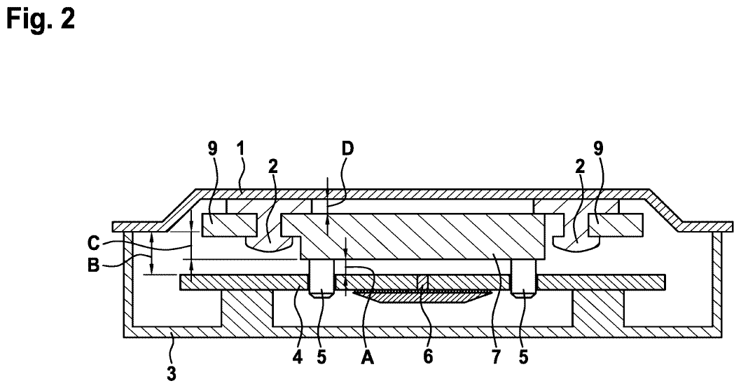

In FIG. 2, a second embodiment example of the radar sensor according to the present invention is shown. Like components are denoted by like reference signs and reference is made to the above description. The second embodiment differs from the first embodiment only in that the waveguide antenna 7 has projections 9, and in that the heat staking pins 2 extend through these projections 9. The heat staking pins 2 are thus located outside the main body of the waveguide antenna 7 so that the main body can be smaller compared to the first embodiment. In the heat staking process, the head of the heat staking pin 2 is pressed against the rear face of the projection 9 by means of heat and pressure and thus deformed so that the waveguide antenna 7 is “clamped” by the heat staking pins 2, and a form-fitting connection is created.

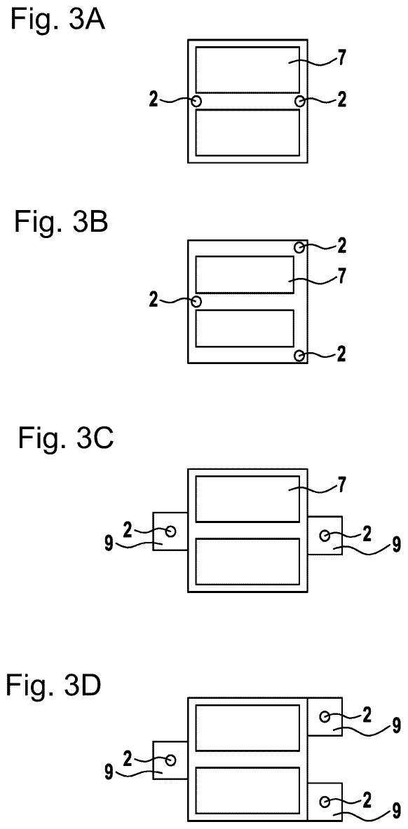

In FIGS. 3A to 3D, top views of the waveguide antenna 7, in each of which the radome 1 is not shown for reasons of clarity, show various example arrangements of the heat staking pins 2 of the radome 1 on the waveguide antenna 7. The arrangements are to be understood as examples only, and other arrangements and a different number of heat staking pins 2 may be used depending on the actual application and available installation space. In FIGS. 3A and 3B, in accordance with the first embodiment, reference being made to the description thereof in connection with FIG. 1, the heat staking pins 2 are connected to the main body of the waveguide antenna 7, in which main body the waveguides are also formed. FIG. 3A shows two heat staking pins 2, which are located on opposite sides of the waveguide antenna 7 and are sufficient for a stable connection between the waveguide antenna 7 and the radome 1. FIG. 3B shows three heat staking pins 2, which form a triangle and with which the stability is further increased. In FIGS. 3C and 3D, in accordance with the second embodiment, reference being made to the description thereof in connection with FIG. 2, a projection 9 is formed on the waveguide antenna 7 for each heat staking pin 2, and the respective heat staking pin 2 is connected to the corresponding projection 9. FIG. 3C shows two projections 9 and two heat staking pins 2 on opposite sides of the waveguide antenna 7, and FIG. 3D shows three projections 9 and three heat staking pins 2, which form a triangle.

1-6. (canceled)

7. A radar sensor, comprising:
a waveguide antenna;
a radome;
a housing to which the radome is fastened; and
a printed circuit board in which the waveguide antenna is positioned;
wherein the waveguide antenna and the radome are connected to each other in a form-fitting manner, the radome having pins which extend through and are connected to the waveguide antenna.

8. The radar sensor according to claim 7, wherein the form-fitting connection is achieved by a heat staking process.

9. The radar sensor according to claim 7, wherein the waveguide antenna has at least one projection, and the form-fitting connection is achieved on the at least one projection.

10. A method for producing a radar sensor, comprising the following steps:
providing a waveguide antenna;
providing a radome;
connecting the radome to the waveguide antenna in a form-fitting manner;
mounting the radome-waveguide antenna assembly on a housing of the radar sensor.

11. The method according to claim 10, wherein the step of connecting in a form-fitting manner is accomplished by a heat staking process.
